(19) United States
(12) Patent Application Publication
(10) Pub. No.: US 2007/0246545 A1
(43) Pub. Date: Oct. 25, 2007

(54) Receiving module with a built-in antenna

(75) Inventor: Robert Wang, Taoyuan (TW)

Correspondence Address: BRUCE H. TROXELL, SUITE 1404, 5205 LEESBURG PIKE, FALLS CHURCH, VA, 22041, US

(73) Assignee: CERAMATE TECHNICAL CO., LTD.

(21) Appl. No.: 11/410,192

(22) Filed: Apr. 25, 2006

(51) Int. Cl. G06K 19/06

(52) U.S. Cl. 235/492

(57) ABSTRACT

A receiving module with a built-in antenna includes a PC board, a radio frequency IC properly sealed on the PC board, a demodulating IC properly sealed on the PC board and connected to the radio frequency IC, a micro antenna properly sealed on the PC board and connected to the radio frequency IC, and a signal output terminal for sending out output signals coming from the demodulating IC, without need of resistance matching between the components. So this module is easy to assemble, taking only a small space, minimizing its size for convenient applicability.

### BACKGROUND OF THE INVENTION

1. Field of the Invention

This invention relates to an antenna, particularly to one provided with a built-in antenna possible to be mounted directly on a circuit board.

2. Description of the Prior Art

In earlier days, fixed outdoor or indoor antennas or fixed mobile antennas were all of a large size, and required to have a proper resistance to comply with that of a receiver. So there should easily occur worse signals received, and nowadays portable built-in or hidden antennas are generally used for notebook computers, PDA (personal digital assistant), cell phones, watches, cameras, etc.

However, portable built-in or hidden antennas available at present are independent from electronic elements such as a radio frequency IC, demodulating IC, giving rise to much inconvenience in assembly, taking much space, and involving resistance matching problems.

### SUMMARY OF THE INVENTION

The feature of the invention is a micro antenna, a radio frequency IC, and a demodulating IC and a microprocessor all properly sealed on a PC board. The micro antenna is connected to the radio frequency IC, and the demodulating IC is connected to the radio frequency IC, so signals coming from the demodulating IC may be send out from an output terminal exposing out of the PC board. The micro antenna is previously selected to match with the other components in their resistance, with all the components sealed on the PC board to become a single module, easily applicable to electrical appliances such as notebook computers, cell phones, cameras, etc.

### BRIEF DESCRIPTION OF DRAWINGS

This invention will be better understood by referring to the accompanying drawings, wherein:

FIG. 1 is a block diagram of the electric circuit of a receiving module with a built-in antenna in the present invention;

FIG. 2 is a perspective view of a first preferred embodiment of the receiving module with a built-in antenna in the present invention; and,

FIG. 3 is a perspective view of a second preferred embodiment of the receiving module with a built-in antenna in the present invention.

### DETAILED DESCRIPTION OF THE PREFERRED EMBODIMENTS

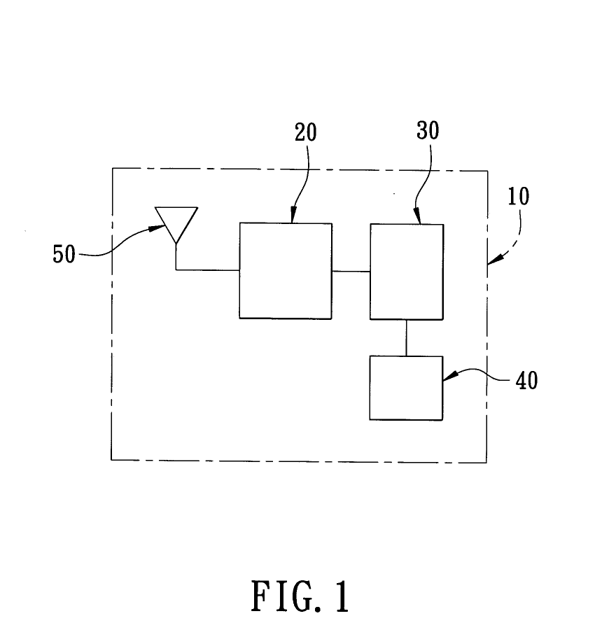

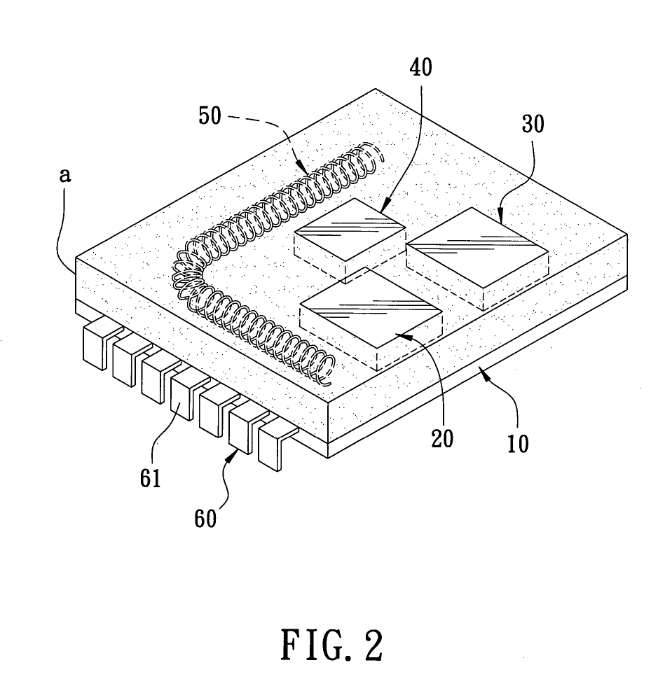

A first preferred embodiment of a receiving module with a built-in antenna in the present invention, as shown in FIGS. 1 and 2, includes a PC board 10, a radio frequency IC 20, a demodulating IC 30, a microprocessor 40, a micro antenna 50 and a signal output terminal 60.

The PC board 10 is to be mounted with the IC components used in the receiving module in the invention thereon.

The radio frequency IC 20 is fixed on the PC board 10 after properly sealed in synthesized resin (a).

The demodulating IC 30 is also fixed on the PC board 10 after properly sealed in synthesized resin (a), connected to the radio frequency IC 20.

The microprocessor 40 is also fixed on the PC board after sealed in synthesized resin (a), connected to the demodulating IC 30 for processing signals coming from the demodulating IC 30.

The micro antenna 50 is also fixed on the PC board after sealed in synthesized resin (a), connected to the microprocessor 40 for transmitting signals processed by the microprocessor 40. It is needed to particularly mention that the radio frequency IC 20, the demodulating IC 30 and the microprocessor 40 can be together sealed and fixed on the PC board 10 with the synthesized resin (a), with the micro antenna 50 not sealed together with those elements.

Next, the signal output terminal 60 is composed of a plurality of pins exposing out of the PC board 10 for sending out signals coming from the demodulating IC 30.

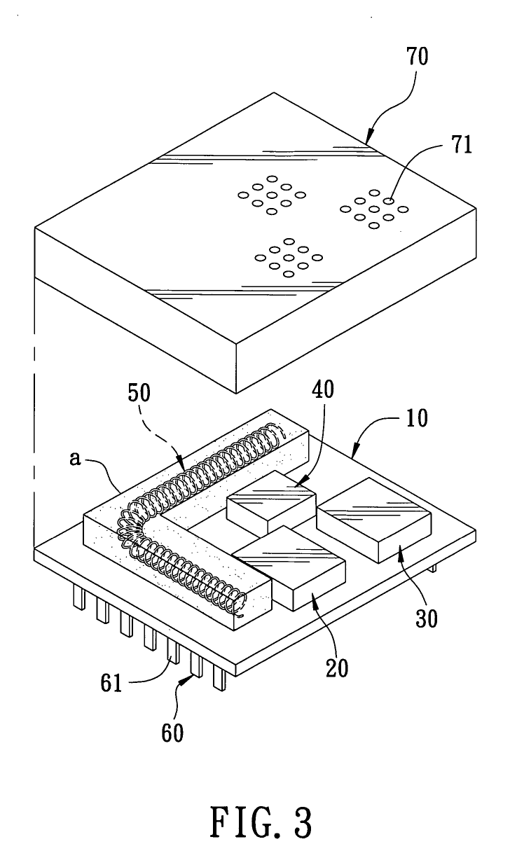

Next, FIG. 3 shows a second preferred embodiment of the receiving module with a built-in antenna in the present invention, having a difference from the first embodiment that the micro antenna 50 is solely sealed in the synthesized resin (a), not together with the other elements, the radio frequency IC 20, the demodulating IC 30 and the micro processor 40 as in the first preferred embodiment, in addition to a metal cover 70 bored with plural small air holes 71 covering on the PC board 10. And the small air holes 71 are located on the radio frequency IC 20, the demodulating IC 30 and the microprocessor 40 respectively for the heat of those components to disperse out.

Moreover, it is particularly necessary to say that the receiving module according to the invention has the radio frequency IC 20, the demodulating IC 30 and the micro processor 40 and even the micro antenna 50 are sealed together and mounted on the PC board 10 with synthesized resin (a), forming a single module, with the micro antenna 50 previously selected to match with the resistance of the other components. Therefore, there may arise no issue about mutual coordination between the components, and in addition, they all are directly sealed on the PC board 10 compactly, taking only a small space, minimizing its size for convenient applicability.

While the preferred embodiments have been descried above, it will be recognized and understood that various modifications may be made therein and the appended claims are intended to cover all such modifications that may fall within the spirit and scope of the invention.

What is claimed is:

1. A receiving module with a built-in antenna, said module comprising:
A PC board;
A radio frequency IC properly sealed and fixed on said PC board;
A demodulating IC properly sealed and fixed on said PC board and connected to said radio frequency IC;
A micro antenna properly sealed and fixed on said PC board and connected to said radio frequency; and,
A signal terminal composed of a plurality of output pins exposing out said PC board and sending out signals coming from said demodulating IC.

2. The receiving module as claimed in claim 1, wherein a micro processor is properly sealed and mounted on said PC board and connected to said demodulating IC, processing signals coming from said demodulating IC and sending them out of said output terminal.

3. The receiving module as claimed in claim 1, wherein said radio frequency IC and said demodulating IC are sealed together with said micro antenna and fixed on said PC board.

4. The receiving module as claimed in claim 1, wherein said radio frequency IC and said demodulating IC are sealed on said PC board and covered by a metal cover covering on said PC board, and said metal cover is bored with plural small air holes locating on said radio frequency IC and aid demodulating IC respectively to let heat generated by said radio frequency IC and said demodulating IC to disperse out of said metal cover.
